(19) United States
(12) Patent Application Publication
(10) Pub. No.: US 2012/0204200 A1
(43) Pub. Date: Aug. 9, 2012

(54) OPTICAL PICKUP DEVICE AND MANUFACTURING METHOD FOR THE SAME

(75) Inventor: Taishi Okazaki, Ora-gun (JP)

(73) Assignee: SANYO Electric Co., Ltd., Moriguchi--shi (JP)

(21) Appl. No.: 13/501,415

(22) PCT Filed: Jul. 28, 2011
(86) PCT No.: PCT/JP2011/004267

§ 371 Date: Apr. 11, 2012

(30) Foreign Application Priority Data
Aug. 18, 2010 (JP) 2010-182923

(51) Int. Cl. G11B 33/04; G11B 7/22; G11B 19/20

(52) U.S. Cl. 720/695; 29/428; G9B/7.138; G9B/19.028; G9B/33.007

(57) ABSTRACT

The invention provides an optical pickup device and a method of manufacturing the optical pickup device that allows an optical device to come to be held after one principal surface of a housing is covered with a covering plate. Most of the principal surface of the optical pickup device provided with the objective lens is covered with the cover. A hole is provided by partially removing the cover at a portion corresponding to the position where a light emitting device is to be disposed. In this manner, even after the housing is covered with the cover, the optical device can be touched through the hole.

This application is the national stage under 35 USC 371 of the International Application No. PCT/JP2011/004267, filed Jul. 28, 2011, which claims priority from Japanese Patent Application Number JP 2010-182923 filed on Aug. 18, 2010, the contents of which are incorporated herein by reference in its entirety.

### FIELD OF THE INVENTION

The present invention relates to an optical pickup device and a manufacturing method for the same. In particular, the present invention relates to a thin optical pickup device including a covering plate for covering a housing, and a method for manufacturing the optical pickup device.

### BACKGROUND OF THE INVENTION

An optical pickup device has functions of irradiating an optical disc with a laser beam with a predetermined wavelength from a light emitting device, and detecting the laser beam reflected on an information recording layer of the optical disc with a light receiving element (Patent Document 1). Accordingly, the optical pickup device can perform operations of reading and writing information from and to optical discs.

In the optical pickup device, optical devices such as a laser device and a light-receiving device are stored in a housing formed by injection molding of a metal or resin material. In addition, a flexible wiring board or the like connected to the optical devices is disposed on a principal surface of the housing, and is covered with a covering plate made of a metal plate of stainless steel or the like.
Patent Document 1: Japanese Patent Application Publication 2005-216436

### SUMMARY OF THE INVENTION

However, once most of one principal surface of the housing is covered with a covering plate, there is a problem that the positions of the optical devices cannot be fixed from the side of the principal surface provided with the covering plate when positioning of the optical devices is performed in the final process.

The present invention has been made in view of such a problem, and it is an object of the invention to provide an optical pickup device and a manufacturing method for the optical pickup device that enable the optical devices to be held from the side of one principal surface of a housing after the one principal surface is covered with a covering plate.

An optical pickup device in the present invention includes: a housing including multiple storage spaces formed by a bottom plate, a side wall extending from a periphery of the bottom plate in a direction perpendicular to the bottom plate, and a partition wall contiguous to the bottom plate or the side wall, and a guide projecting from the side wall and configured to movably hold a supporting shaft, the housing having openings of the storage spaces set on its upper side; an optical device fixed to one of the storage spaces; an actuator stored in one of the storage spaces, and having an objective lens or a holder holding the objective lens on the upper side; a board covering surroundings of the objective lens or the holder holding the objective lens; a circuit component provided on the board at a portion contiguous to the objective lens or the holder holding the objective lens in a moving direction of the supporting shaft; and a cover covering the board and the circuit component, wherein an area of the cover which covers a top portion of the circuit component or the circuit component is lifted up from the other area.

In addition, an optical pickup device in the present invention includes: a housing including a bottom plate, a side wall surrounding the bottom plate and extending perpendicularly from the bottom plate, a partition wall extending from an inner side of the bottom plate or the side wall, a storage space having at least the partition wall, an opening of the storage space disposed on an upper side that is opposite to the bottom plate; a recessed region penetrating a portion of a rear surface of the housing and forming a storage space with the partition wall surrounding the penetrated portion; an optical device stored in the recessed region; and a plate-shaped cover covering the upper side of the housing, wherein a hole is provided by removing the cover at a portion covering the recessed region.

One aspect of the present invention is a method of manufacturing an optical pickup device configured to emit a laser beam to an information recording medium, and detect the laser beam reflected by the information recording medium, the method comprising the steps of: preparing a housing having a first principal surface and a second principal surface, the housing being provided with a recessed region, and storing an optical device connected to a flexible wiring board from the first principal surface side to the recessed region; covering the flexible wiring board disposed on the first principal surface of the housing, with a cover provided with an opening at a position where the optical device is to be disposed; and positioning the optical device, wherein, in the step of positioning, the optical device is pressed from the first principal surface side by a pressing unit inserted into the housing through the hole of the cover.

According to the present invention, a covering plate covering one principal surface of the housing is partially removed to have an opening. Thus, when an optical device mounted therein is positioned, the optical device can be supported via the opening.

In addition, providing an opening in the covering plate is advantageous in reducing the weight of the covering plate.

### BRIEF DESCRIPTION OF DRAWINGS

FIGS. 1A and 1B are views of an optical pickup device in the present invention; FIG. 1A is a perspective view illustrating the optical pickup device arranged with the surface provided with a cover being the upper surface of the optical pickup device; and FIG. 1B is a perspective view illustrating the optical pickup device with the cover being removed.

FIGS. 2A and 2B are views of the optical pickup device in the present invention; FIG. 2A is a perspective view of the optical pickup device with the front and the back being reversed; Fig. B is an enlarged perspective view of an portion of the optical pickup, to which a LD for BD is fixed.

FIGS. 3A and 3B are views of the optical pickup device in the present invention; FIG. 3A is a perspective view illustrating a manner in which the LD for BD is supported by a flexible wiring board; and FIG. 3B is a cross-sectional view illustrating a manner in which the LD for BD is stored in the housing.

FIG. 4 is a view illustrating the optical devices included in the optical pickup device in the present invention.

FIGS. 5A and 5B are views illustrating a manufacturing method of the optical pickup device in the present invention; FIG. 5A is a view illustrating the flexible wiring board in a developed state; and FIG. 5B is a perspective view illustrating the flexible wiring board in a bent form.

FIGS. 6A and 6B are views illustrating a manufacturing method of the optical pickup device in the present invention; FIG. 6A is a perspective view illustrating a step of positioning the LD for BD; and FIG. 6B is a cross-sectional view when the step is performed.

FIG. 7 is a view illustrating the optical disc device which includes the built-in optical pickup device in the present invention.

FIG. 8 is a view illustrating an external shape of the optical pickup device in the present invention.

FIG. 9 is a view partially illustrating the optical disc device which includes the built-in optical pickup device in the present invention.

FIG. 10 is a view illustrating an external shape of the optical pickup device in the present invention.

### DETAILED DESCRIPTION OF THE INVENTION

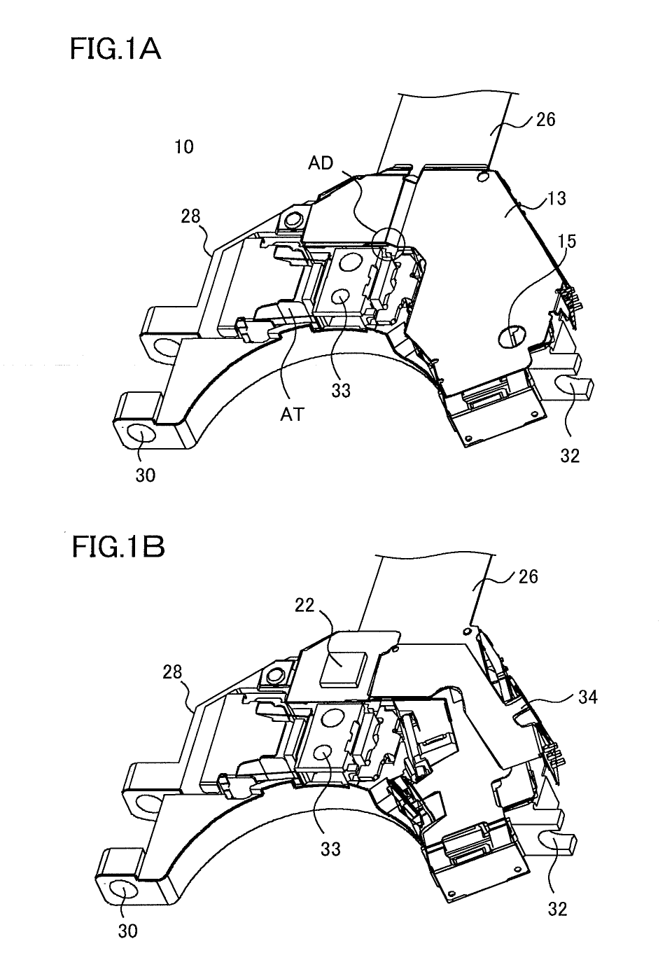

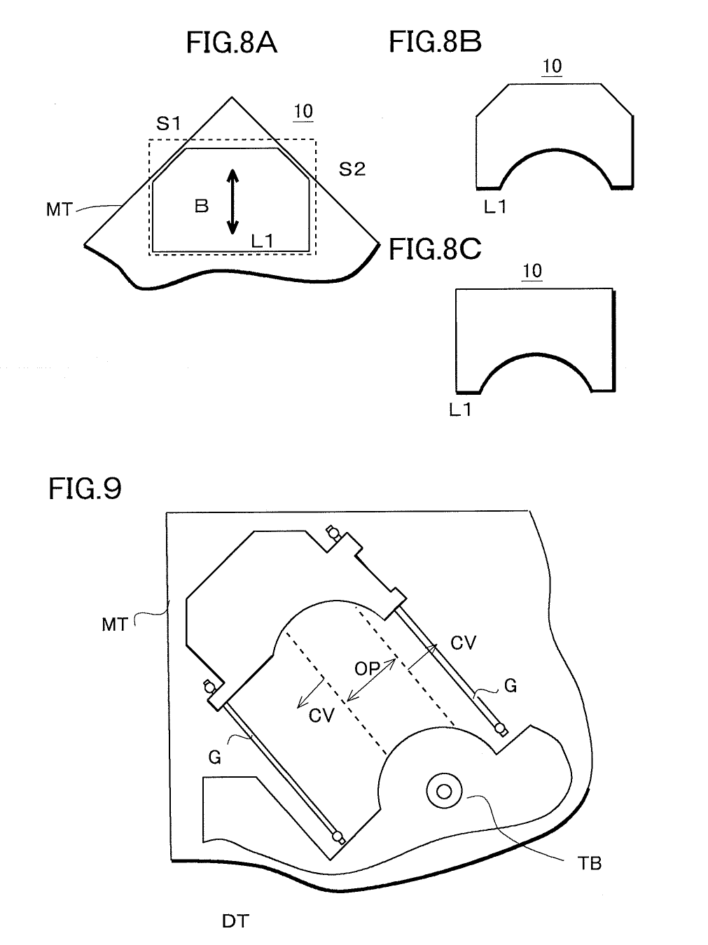

The configuration of an optical pickup device 10 is described with reference to FIG. 1. FIG. 1A is a perspective view illustrating the optical pickup device of in the present embodiment, and FIG. 1B is a perspective view illustrating the optical pickup device 10 with a cover 13 being removed. In the following description, a principal surface of a housing 28 on which an objective lens 33 is exposed is referred to as an upper surface, and another principal surface of the housing 28 opposite to the upper surface is referred to as a lower surface. The housing 28 is a BOX-shaped as described later, and there is a thick bottom plate at the lower surface, and a side wall is perpendicularly extended from the periphery of the bottom plate. The lens side of the bottom plate is defined as the front side, and the side of the bottom plate opposite to the lens is defined as the back side. The housing side of the side wall is defined as the inner side and the side of the side wall opposite to the housing is defined as the outer side. The housing 28 may have various planar shapes, however, when a curved portion is ignored, the housing 28 is a rectangular shape or a rectangular shape with two corners being cut as illustrated in FIGS. 8B and 8C.

The optical pickup device 10 has functions of focusing a laser beam compliant with BD (Blu-ray Disc), DVD (Digital Versatile Disc), or CD (Compact Disc) standard onto an information-recording layer of an optical disc (information recording medium), receiving reflection light from the information-recording layer, and converting the reflection light into an electric signal. The optical pickup device 10 includes a light emitting chip for BD, and a light emitting chip for DVD and CD.

The laser beams emitted from the optical pickup device 10 are a laser beam for BD (blue violet wavelength band of 400 nm to 420 nm); a laser beam for DVD (red wavelength band of 645 nm to 675 nm); and a laser beam for CD (infrared wavelength of 765 nm to 805 nm). Here, the optical pickup device 10 is not necessarily incorporated as a system which is compatible with the three types of laser beams, and may be incorporated as a system which is compatible with one type of two types of laser beams.

The optical pickup device 10 includes the housing 28, various optical devices built in the housing 28, a flexible wiring board 26 electrically connected to the optical devices, and a cover 13 covering the upper surface of the housing 28. As illustrated in FIG. 1A, an actuator AT which has an built-in objective lens is exposed through the cover 13.

The housing 28 is composed of a resin material or a metal material (for example, magnesium alloy) which is integrally formed by injection molding, and various optical devices are disposed at the bottom plate and side wall inside the BOX. The side walls parallel to the driving direction of the objective lens 33, i.e., the opposing side walls of the housing 28 are respectively provided with a first guide having a guide hole 30 and a second guide having a guide groove 32 integrally with the side walls. As illustrated in FIG. 9, while the optical pickup device 10 is being used, a guide shaft is inserted in the guide hole 30, and another guide shaft is engaged in the guide groove 32. Thus, the optical pickup device 10 moves in a radial direction of the disk along the guide shafts.

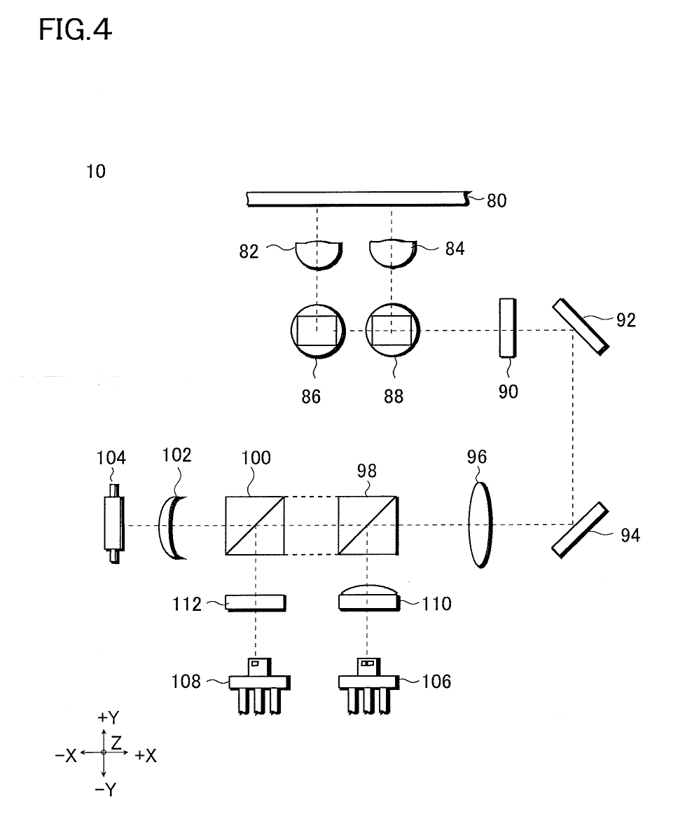

Partition walls extending from the bottom plate or the side wall are disposed inside the housing 28, and multiple storage spaces are provided to which the optical devices illustrated in FIG. 4 are attached. One of the storage spaces of the housing 28 has the external shape of the actuator. The objective lens is located at the upper surface of the housing 28 or is slightly projecting from the upper surface of the housing 28, and the actuator which can movably hold the objective lens 33 is disposed. A portion of the upper surface of the housing 28, the portion excluding at least the install area of the objective lens, is provided with the flexible wiring board 26 in a folded state.

The cover 13 (covering plate) is formed by performing bending processing on a thin metal plate into a predetermined shape, the metal plate being composed of a metal material mainly containing stainless steel, aluminum, or copper, and the cover 13 covers the upper surface of the housing 28. Specifically, most portion of the upper surface of the housing 28 is covered by the cover 13, excluding the portion where the actuator for supporting the objective lens 33 is disposed. Accordingly, the interior space of the housing 28, which has built-in optical devices such as a prism, is sealed with the cover 13, and thus entry of dust and the like into the interior space from the outside is prevented. In addition, entry of light into the interior space of the housing 28 from the outside is also prevented.

Furthermore, an inner end of the location to which a level difference portion of the cover 13 is disposed is fixed to the housing 28 or the actuator AT via an adhesives AD such as an epoxy resin.

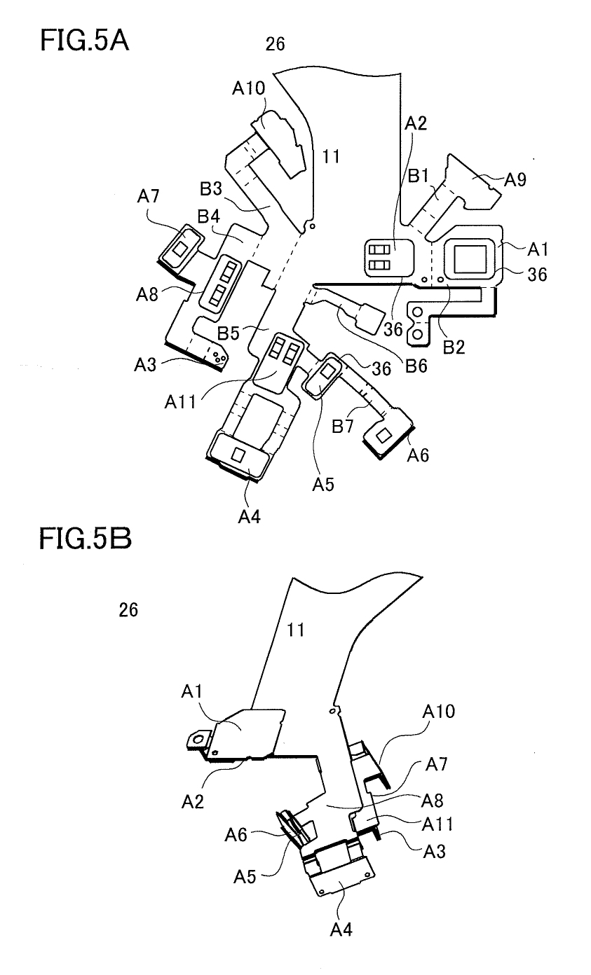

Referring to FIG. 1B, the flexible wiring board 26 connects the optical devices built in the optical pickup device 10 to the outside. In addition, the flexible wiring board 26 is fixed to a portion of the upper surface of the housing 28 with undergoing multiple bending processing and being folded. The specific configuration of the flexible wiring board 26 is described later with reference to FIG. 5.

On the other hand, the flexible wiring board 34 connects a LD for DVD and a LD for CD as one of a first optical device to a package 22 which has built-in control devices (a semiconductor chip and/or a chip device) to control the above LDs, and a circuit pattern is formed in both principal surfaces of the base material. The wiring of the circuit pattern formed in both surfaces of the flexible wiring board 34 is thicker than the wiring of the circuit pattern formed in the flexible wiring board 26.

A hole portion 15 illustrated in FIG. 1A is a section part where an opening of the cover 13 is partially made, and is provided at a position corresponding to the position where an optical device such as a LD is installed. In the present embodiment, as describes later, the hole 15 is formed at a position corresponding to the position where a LD for BD (laser device) is disposed. Therefore, the LD for BD stored in the housing 28 can be visually recognized through the hole 15, or a folded flexible sheet can be seen through the hole 15, and the LD is disposed below the flexible sheet.

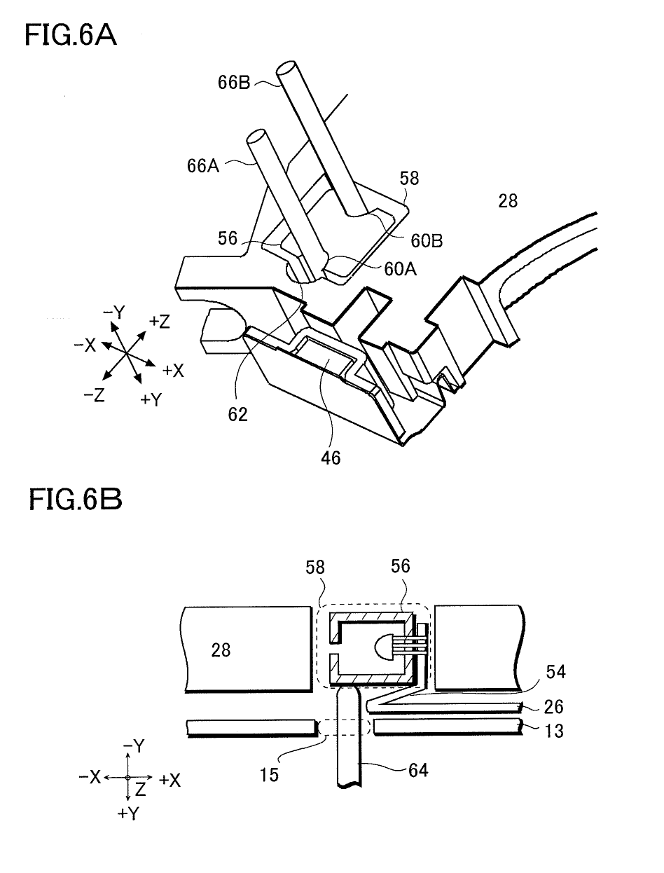

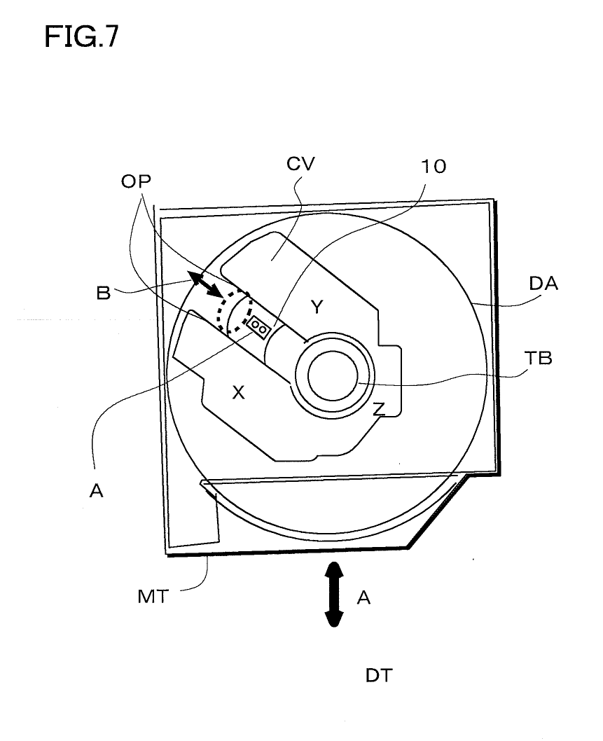

By providing the cover 13 with the hole 15, positioning of the LD56 can be performed after installing the cover 13 on the housing 28. Specifically, after the optical devices such as an LD for BD are temporarily attached to the storage spaces provided inside the housing 28, the cover 13 is fixed to the principal surface of the housing 28. A contacting unit of a presser bar is inserted into the hole 15 of the cover 13, and positioning of the LD for BD and fixing thereof are performed. The detail of this step is described later with reference to FIG. 6.

In addition, by providing the cover 13 with the hole 15, a state of the built-in optical devices can be visually inspected from the outside through the hole 15. Furthermore, with the hole 15 provided, the weight of the cover 13 is reduced, thereby contributing to reduction of the overall weight of the optical pickup device 10. The hole 15 may be provided as needed at the position where the optical devices such as other LD and prism are disposed so that positioning can be performed.

The shapes of the housing and the cover are described with reference to FIGS. 7 to 10. FIG. 7 illustrates part of a portable PC, or a station PC on which the optical pickup device 10 in FIG. 1 is mounted. When a portion of the PC is lightly pushed, a table DT for loading optical disc in FIG. 7 appears.

The table DT is BOX (MT) whose outer side is composed of metal, and the thickness is approximately 1 cm or less. The portion indicated by a circle in FIG. 7 is the disk area (DA) where a disk is to be disposed, and there is a turntable (TB) at the center where the disk is fixed. The portion of the disk area (DA) is mainly composed of a resin, and a printed board or the like is mounted on the back side of the disk area. A cover (CV) partially composed of metal is disposed. The cover (CV) has a U-shape. That is to say, the cover (CV) has a U-shape including a lower projecting portion X, an upper projecting portion Y, and a bottom portion Z, and there is an opening (OP) with no cover provided between the two projecting portions.

The opening OP has such a width that at least the objective lens 33 can be exposed, and is provided to be long in the radial direction, and the optical pickup device 10 is disposed in an area at the opening. This is an area where the optical pickup device 10 moves in the radial direction, and is opened because incoming and outgoing of light are necessary. The cover (CV) may be composed of the same material as that of the resin cover in the disk area (DA).

Referring back to FIG. 1, guide shafts are respectively inserted into the guide hole 30 and the guide groove 32 so that the optical pickup device 10 is moved exactly in the direction of an arrow B in FIG. 7. The opening of the cover (CV) has a width which allows the objective lens 33 and a holding portion of the objective lens to be substantially exposed, and the rest of the opening is covered with the cover (CV) and/or a resin cover of the disk area.

In FIG. 1B, the package 22 for control is disposed above the actuator provided with the objective lens 33 in the drawing. The portion here is the bent portion of the flexible sheet, in which electronic components such as an IC are disposed, and projects upwards compared with other area. The portion is the area enclosed by a dotted line of FIG. 7, and can be made thicker than other area because the portion is in the opening with a cover removed. If the flexible sheet and the package 22 are disposed in the other area, the thickness of the optical pickup device 10 at the portion of the cover is increased, thus the flexible sheet and the package 22 are disposed in the portion indicated by the dotted line, and then the surface of the cover (CV) is slightly lifted up in the thickness direction from the middle of the cover. The elements causing the thickness of the optical pickup device 10 to increase are disposed in the opening area, and thus it is advantageous in reducing the thickness of the optical pickup device 10 accordingly. As a matter of course, the elements may be disposed in a certain range for which contact with the optical disc is avoided. As above-described above, it may be described that the elements are disposed up to substantially the projecting top of the objective lens 33.

Thus, referring to FIG. 1B, the flexible sheet is folded multiple times in the portion here so that many layers are formed. The number of times of folded the flexible sheet at the portion here is more than that in other portion. The pattern for disposing the package 22 is arranged to face upward by folded the flexible sheet. The conductive pattern is provided with components such as a chip device, an IC, a variable resistance, and a variable capacity, and thus has a thickness thicker than the other area. Therefore, in FIG. 1A, the cover 13 is lifted up and formed in a raised shape. For example, when the flexible sheet is formed by a conductive pattern with a single layer on one side, the conductive pattern can be disposed on the surface depending on how the flexible sheet is folded, and thus a multilayered sheet for which conductive patterns are formed on both sides does not need to be prepared.

The shape and arrangement of the optical pickup device 10 are described with reference to FIGS. 8 and 9. Basically, the two-dimensional external shape of the optical pickup device 10 can be any figure such as a rectangle, or a circle. For example, it is assumed that the optical pickup device 10 has a rectangular shape as illustrated by the dotted line of FIG. 8A. Now, when the optical pickup device 10 is moved in the diagonal direction of the rectangular metal BOX (MT), i.e., the direction of the arrow B, the moving distance of the objective lens 33 is increased as much as possible by cutting off the corners S1 and S2,

Further, in order to slide the turntable TB into a side L1 which is opposite to a side sharing the corner S1, part of the side L1 is partially curved. Consequently, the shape of FIG. 8B is completed. This is the shape obtained by cutting off two corners of the rectangle and cutting the longer side L1 with the radius curve of the turntable, the longer side L1 sharing no cut off corner.

On the other hand, when the optical pickup device 10 is moved at non diagonal line area of the metal BOX, the optical pickup device 10 may be a rectangle as in FIG. 8C, and the radius curve of the turntable may be provided in the longer side L1.

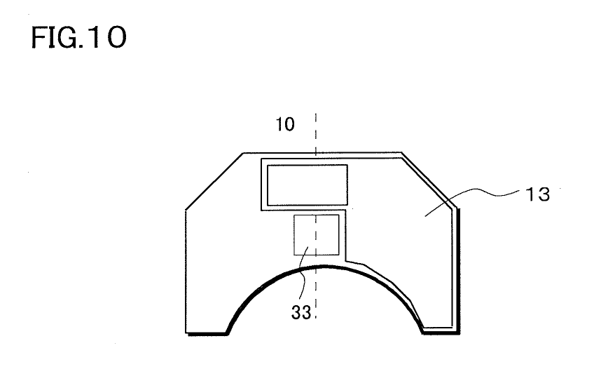

Subsequently, FIG. 10 schematically illustrates the cover 13 in FIG. 1. In the two-dimensional shape described above, the objective lens 33 or the holder of the objective lens is disposed on the curved side at the center line illustrated by a dotted line. Thus, the cover 13 covers the right side of the center line excluding the holder. The cover 13 above the holder is lifted up.

Consequently, the cover 13 allows the optical devices to be positioned via the hole 15, and can protect incorporated components, i.e. the flexible sheet provided under the lifted-up portion, and electronic components mounted on the flexible sheet thanks to the lift-up of the cover. A short circuit or the like can be also prevented.

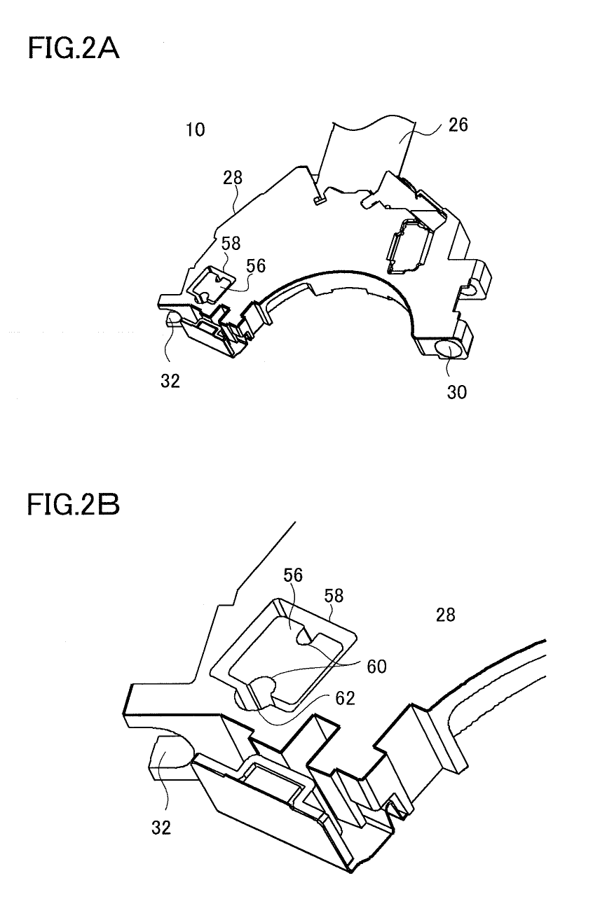

Next, referring to FIG. 2, the LD56 for BD exposed through the hole 15 provided in the above-described cover is described. FIG. 2A is a perspective view illustrating the lower surface of the optical pickup device 10, and FIG. 2B is an enlarged perspective view illustrating the portion in which the LD56 for BD is stored.

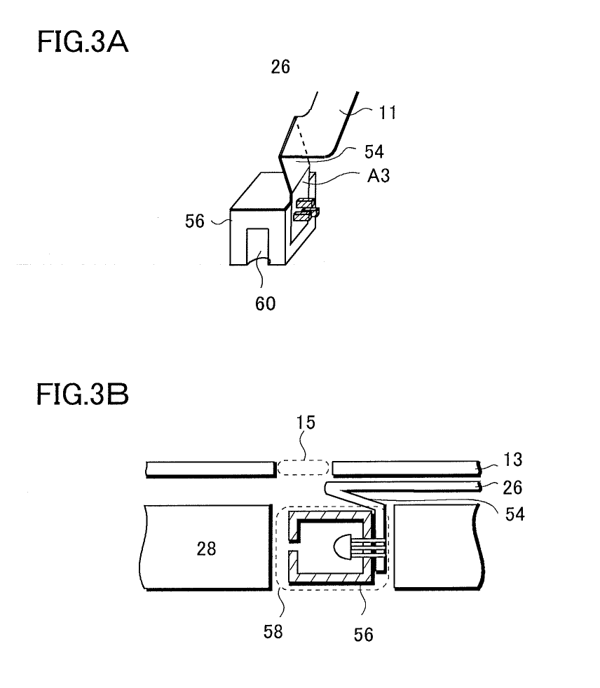

Referring to FIG. 2A, a recessed region 58 is a quadrilateral-shaped region penetrating through the bottom plate of the housing 28 in the thickness direction, and four partition walls are provided around the recessed region 58 toward the upper surface of the optical pickup device 10. In FIG. 2B, the inner side walls of the partition walls are seen. The LD56 for BD is stored in a space surrounded by the partition walls. Here, the LD56 for BD has a built-in laser diode which emits a laser beam of the BD standard, and is a package of CAN type or lead frame type. In the present embodiment, the external shape of the LD56 for BD has a rectangular parallelepiped shape or a cubic shape having the upper surface, the, lower surface, and four side surfaces in accordance with the shape of the recessed region 58. The side surface of the LD56 for BD facing the inner wall of the recessed region 58 has a drawn-out lead, which is connected to an end of the flexible wiring board 26. The connection configuration is described later with reference to FIG. 3.

Referring to FIG. 2B, a recessed portion 60 is provided by partially inwardly denting the facing side surface of the LD56 for SD. The recessed portion 60 is a portion which allows a jig for positioning (for example, a tool like tweezers) to pinch when positioning of the LD56 for BD is performed. Furthermore, a dented region 62 is provided by denting the inner wall of a recessed region 58 opposed to the recessed portion 60 of the LD56 for BD. By providing the dented region 62, the jig for performing positioning of the LD56 for BD can be easily inserted into the recessed region 58. Further, a degree of freedom in the movement of the jig in a process of positioning the LD56 for BD improves.

Referring to FIG. 3A, the LD56 for BD is stored in the recessed region 58 of the housing with being suspended from a bent portion 54 of the flexible wiring board 26. Specifically, referring to FIG. 3B, the flexible wiring board 26 attached to the bottom of the LD56 is once bent at a corner of the bottom surface of the LD56 along the side surface of the LD, then is bent 180 degrees in the middle of the side surface, and extends between the cover 13 and the housing 28. A wiring section 11 of the flexible wiring board 26 and an LD mounting section for BD A3 are contiguous via the bent portion 54. Therefore, even when the LD56 moves, the bending angle of the bent portion 54 only slightly varies, and the LD56 for BD is connected to the flexible wiring board 26 while allowing positioning of the LD56.

The LD mounting section for BD A3 (refer to FIG. 5) provided in the end of the flexible wiring board 26 has a lead fixed thereto projecting outward from the side surface of the LD56 for BD. In addition, the LD mounting section for BD A3 is disposed at the bottom surface (the side where a lead is projecting) of the LD56 for BD.

Referring to FIG. 3B, in the present embodiment, the flexible wiring board 26 is disposed on the upper surface of the housing 28 which houses various optical devices with the flexible wiring board 26 being folded, and the upper surface is covered with the cover 13. The LD56 for BD is exposed through the hole 15 provided in the cover 13.

In FIG. 3B, the LD56 is a rectangular parallelepiped, of which the upper surface (left side of FIG. 3B) has an opening of a package as a light emitter, the side provided with a lead is the bottom, and there are four side surfaces surrounding the bottom.

Next, referring to FIG. 4, the optical devices stored in the housing of the optical pickup device 10 are described.

The optical pickup device 10 includes objective lenses 82, 84, reflecting mirrors 86, 88, a ¼ wavelength plate 90, reflective plates 92, 94, a collimating lens 96, prisms 98, 100, anamorphic lens 102, PDIC104, diffraction gratings 110, 112, and laser devices 106, 108.

The laser device 108 is a device in which a light emitting device which emits a laser beam is packaged on a disk 80 in the SD standard.

The laser device 106 is a package of a light emitting device which emits a laser beam incorporated in a disk 80 in the DVD and the CD standard.

Here, the laser devices 106, 108 may be a package of what is called CAN type or lead frame type. In addition, the BD, DVD, and CD may be a device which emits light from one package. In this case, a diffraction grating and a prism which are located in either one of the paths of the LD in FIG. 4 can be omitted.

The diffraction grating 110 has a function of separating a laser beam (the DVD standard or the CD standard) emitted from the laser device 106 into a zero-order diffracted light, a positive first-order diffracted light, and a negative first-order diffracted light.

Similarly, the diffraction grating 112 has a function of separating a laser beam in the BD standard emitted from the laser device 108 into the zero-order diffracted light, the positive first-order diffracted light, and the negative first-order diffracted light.

The anamorphic lens 102 is a lens for providing an aberration to a passing laser beam, and is also referred to as an anamorphic lens.

The PDIC104 has a built-in photo diode integrated circuit element which serves as a photodetector for signal detection, receives a laser beam of the BD standard, the DVD standard, or the CD standard, and generates a light-receiving output including an information signal component. Furthermore, the PDIC104 generates a servo signal component used for focusing servo and tracking servo.

The prism 100 has a built-in reflection plane which has polarization selectivity for the laser beam in the BD standard emitted from the laser device 108. The laser beam which is a linearly polarized light in S direction emitted from the laser device 108 is reflected in the +X direction by the reflection plane of the prism 100. Returning light on a return path which is reflected by the disk 80 is made a linearly polarized light in P direction by the effect of the ¼ wavelength plate 90, and is transmitted through the reflection plane of the prism 100 in the -X direction.

The prism 98 has a built-in reflection plane which has a wavelength selectivity and a polarization selectivity. Specifically, the prism 98 allows a laser beam in the BD standard emitted from the laser device 108 to pass through regardless of a polarization direction. On the other hand, a laser beam in the DVD standard or the CD standard which is emitted from the laser device 106 is reflected by or transmitted through the reflection plane of the prism 98 according to a polarization direction. Specifically, a laser beam in the DVD standard or the CD standard is emitted from the laser device 106, and the laser beam is linearly polarized light in the S direction. A laser beam emitted in the +Y direction from the laser device 106 is reflected in the +X direction by the reflection plane of the prism 98, then passes through various optical devices to reach the disk 80. A laser beam as returning light reflected by the information-recording layer of the disk 80 is converted into linearly polarized light in the P direction by the effect of the ¼ wavelength plate 90, and passes through the reflection plane of the prism 98 from the +X direction to the −X direction.

The collimating lens 96 is a lens for collimating laser beams emitted from the laser devices 106, 108 into parallel beams.

The reflective plates 92, 94 are for reflecting laser beams emitted from the laser devices 106, 108 in a determined direction. Here, the reflectivity of the reflective plates 92, 94 for a laser beam may be 100%, or may be adjusted to the reflectivity of a laser beam with a specific wavelength or a polarization direction in order to compensate the function of the prisms 98, 100.

The ¼ wavelength plate 90 is an optical device which causes a phase difference in an incident laser beam. Therefore, when a linearly polarized laser beam in the S direction is emitted from the laser devices 106, 108 passes through the ¼ wavelength plate 90, the laser beam is converted into a circularly polarized laser beam. Furthermore, the circularly polarized laser beam, when being reflected by the information-recording layer of the disk 80 and being transmitted through the ¼ wavelength plate 90 again, is converted into a linearly polarized laser beam in the P direction.

The reflecting mirror 88 includes a reflection plane having a frequency selectivity, and reflects a laser beam in the DVD and the CD standard in the +Y direction, while allowing a laser beam in the BD standard to pass through in the −X direction.

The reflecting mirror 86 reflects a laser beam in the BD standard in the +Y direction, the laser beam having passing through the reflecting mirror 88.

The objective lens 84 focuses a laser beam in the DVD standard or the CD standard to the information-recording layer of the disk 80, the laser beam having been reflected by the reflecting mirror 88.

The objective lens 82 focuses a laser beam in the BD standard to the information-recording layer of the disk 80, the laser beam having been reflected by the reflecting mirror 86.

Next, the operation of the optical pickup device 10 configured in the above manner is described. Write operation is basically the same as read operation, and the write operation uses a laser beam with a higher intensity than that used for the read operation.

First, the optical path of a laser beam in the DVD standard and the CD standard is described. A laser beam emitted from the laser device 106 is separated into the zero-order diffracted light, the positive first-order diffracted light, and the negative first-order diffracted light by the diffraction effect of the diffraction grating 110. Here, the laser beam emitted from the laser device 106 is a linearly polarized light in the S direction.

The separated laser beam is then reflected by the reflection plane of the prism 98, and is reflected by the reflective plates 94, 92 and is transmitted through the ¼ wavelength plate, and thus a linearly polarized light is converted to a circularly polarized light.

Subsequently, the circularly polarized laser beam is reflected by the reflecting mirror 88, and then is focused on the information-recording layer of the disk 80 by the objective lens 84.

A laser beam as returning light reflected by the information-recording layer of the disk 80 is transmitted through the objective lens 84, then is reflected by the reflecting mirror 88 and is transmitted through the ¼ wavelength plate. In this manner, the laser beam as a circularly polarized light is converted into a linearly polarized light in the P direction.

The laser beam which has undergone the conversion of a polarization direction is reflected by the reflective plates 92, 94, then is transmitted through the collimating lens 96 and the prisms 98, 100, and is provided with aberration by the anamorphic lens 102, then reaches PDIC104.

Information is read in the PDIC 104, and focusing servo and tracking servo are performed based on the read information.

Next, the optical path of a laser beam in the BD standard is described.

First, a laser beam in the BD standard which is a linearly polarized light in the S direction is emitted from the laser device 108. The emitted laser beam in the BD standard is separated into three laser beams by the diffraction grating 112, and then is reflected by the reflection plane of the prism 100. The reflected laser beam is transmitted through the prism 98, then is converted into a parallel beam by the collimating lens 96 and is reflected by the reflective plates 94, 92 to reach the ¼ wavelength plate 90.

The laser beam which has been converted by the ¼ wavelength plate 90 from a linearly polarized light into a circularly polarized light is transmitted through the reflecting mirror 88, and is reflected in the +Y direction by the reflection plane of the reflecting mirror 86. The laser beam then is focused on the information-recording layer of the disk 80 by the objective lens 82.

A laser beam as returning light reflected by the information-recording layer of the disk 80 is transmitted through the objective lens 82 and is reflected by the reflecting mirror 86, then is transmitted through the reflecting mirror 88 and is made incident to the ¼ wavelength plate 90. The ¼ wavelength plate 90 converts a circularly polarized light into a linearly polarized laser beam in the P direction. Subsequently, the laser beam as a linearly polarized light in the P direction is reflected by the reflective plates 92, 94 and is transmitted through the collimating lens 96 to reach the prism 98.

The laser beam in the BD standard as a linearly polarized light in the P direction is transmitted through the prism 98 and the prism 100, and is provided with aberration by the anamorphic lens 102 and the PDIC104 is irradiated with the laser beam. Information is then read in the PDIC 104, and focusing servo and tracking servo are performed based on the read information.

Referring to FIG. 5, the overall configuration of the flexible wiring board 26 which is used for the optical pickup device in the present embodiment is described. FIG. 5A is a plan view illustrating the flexible wiring board 26 in a developed state, and

FIG. 5B is a perspective view illustrating the flexible wiring board 26 with being incorporated in the optical pickup device. Here, FIG. 5A illustrates a wiring pattern with a single layer, which is disposed on the upper surface of the flexible wiring board 26. FIG. 5A and FIG. 5B illustrate the flexible wiring board 26 with the front and the back being reversed. In FIG. 5A, the dotted line illustrates the line along which the flexible wiring board 26 is bent.

Referring to FIG. 5A, the flexible wiring board 26 is provided with section parts on which the optical devices constituting the optical pickup device 10 are respectively mounted. Specifically, the flexible wiring board 26 is provided with a control device mounting section Al on which the control devices to control the LD for DVD and the LD for CD are mounted, a chip device mounting section A2, an LD mounting section for BD A3, a PDIC mounting section A4, an FMD mounting section A5, a package mounting section A6, a package mounting section A7, a chip device mounting section A8, a connection terminal section A9, a connection terminal section A10, and a chip device mounting section A11. The section parts are contiguous via the wiring section 11 of the flexible wiring board 26.

The wiring section 11 has the greatest width in the flexible wiring board 26, and is formed to be the longest in the flexible wiring board 26. One end of the flexible wiring board 26, i.e., a portion around the chip device mounting section A2 is a rectangular region with an area to some extent. The rectangular region is provided integrally with two branch-shaped wiring sections B1, B2 on the right side, and the wiring section 11 on the top side. In addition, four branch-shaped wiring sections B3 to B6 are provided on the left side.

The wiring sections B1, B4, and B5 are provided with the chip device mounting sections A2, A8, and A11, respectively, and a resistor, a capacitor, or a coil each in chip type is mounted by solder connection.

The wiring section B7 branched from the wiring section B5 is provided with the package mounting section A6, and a volume resistance that determines the sensitivity of FMD is disposed on a package which is fixed to the package mounting section A6. The wiring section B4 is provided with the package mounting section A7, and a package is mounted on the package mounting section A7, the package having a built-in superposition IC for superposing a superposition frequency on the current supplied to the LD for BD.

The wiring sections B1, B3 are respectively provided with the connection terminal sections A9, A10 which are each provided with a pad including a wiring pattern, and the pad is a section part for electrically connecting to a motor or the like which is built in the housing.

Furthermore, the wiring section B2 is provided with a section part on which a control device and a chip device are mounted, and a reinforcing plate 36 is affixed to the section part. The reinforcing plate 36 is composed of a resin material (for example, a epoxy resin containing a fibrous filler) whose mechanical strength is stronger than the base material of the flexible wiring board 26. In addition, the reinforcing plate 36 is affixed to the principal surface of the base material on which a wiring pattern is not provided. Here, the reinforcing board 36 is indicated by a region with cross-hatching.

The chip parts and the like to be connected by soldering can be stably fixed by reinforcing the flexible wiring board 26 with the reinforcing plate 36. Furthermore, deformation and bending of the flexible wiring board 26 are reduced, thus the flexible wiring board 26 can be fixed to the housing with high accuracy.

Referring to FIG. 5B, the flexible wiring board 26 in the above-described configuration is incorporated in the optical pickup device with the flexible wiring board 26 undergoing multiple bending processing. Here, the wiring section B1 is bent along the line of bending so that the control device mounting section A1 and the chip device mounting section A are superimposed on each other. The wiring section B4 presents a state where the LD mounting section for BD A3, the chip device mounting section A11, the chip device mounting section A8, and the package mounting section A7 are folded. The FMD mounting section A5 of the wiring section B7 undergoes bending processing so that the FMD faces the inner side, and the package mounting section A6 near the distal end is also bent so as to face the inner side. In addition, the connection terminal section A10 undergoes bending processing so that the wiring pattern faces the inner side.

Next, the manufacturing method of the optical pickup device of a configuration of having described above is described.

Referring to FIG. 6A, first, the optical components constituting the optical pickup device are incorporated in the housing 28. Specifically, various optical devices described in FIG. 4 are incorporated in the storage spaces which are formed with any of the bottom plate, the side wall and the partition walls that are described above.

Here, the electrically connected optical devices (the laser devices 106, 108, the PDIC104 illustrated in FIG. 4) are provided in the housing 28 with the optical devices being connected to the flexible wiring board 26 or the flexible wiring board 34 illustrated in FIG. 1B. Furthermore, in the flexible wiring board 26, devices configured to control the optical devices and devices (a resistor, a condenser, a coil) configured to adjust characteristics of the optical devices are connected via solder. Here, as described above, the flexible wiring board 26 has a wiring structure with a single layer, and is included in the housing with the bending portions being bent in a complicated manner. Other optical devices (the prism 100 and the like illustrated in FIG. 4) which are not electrically connected are fixed to the relevant storage spaces inside the housing 28 via an insulating bonding material.

Next, the step of positioning the LD56 for BD is described. FIG. 6A is a perspective view illustrating the step, and FIG. 6B is a cross-sectional view.

First, the LD56 for BD is stored in the recessed region 58 of the housing 28 with the LD56 for BD being temporarily attached to the flexible wiring board 26 having the bending portion 54 (refer to FIG. 6B).

Referring to FIG. 6A, the recessed portions 60A, 60B that are formed in both side surfaces of the LD56 for BD are held by holding units 66A, 66B. Holding units 66A and 66B are crowded on both sides of recessed portions 60A and 60B, and hold LD56 for BD.

The dented region 62 is provided by denting the inner wall of the recessed region 58, and accordingly, the holding units 66A, 66B can be easily inserted into the recessed region 58. Furthermore, a movable range of the holding units 66A, 66B in the Z direction increases, thus positioning of the LD56 for BD can be performed more appropriately.

In this step, when the LD56 for BD is held by the holding units 66A, 66B, the LD56 for BD is pressed by the presser bar 64 from the opposite side of the housing 28 as illustrated in FIG. 6B.

Specifically, as illustrated in FIG. 6A, when the LD56 for BD is attempted to be held simply by the holding units 66A, 66B from the lower surface of the housing 28, the LD56 for BD may go down. In this case, it is difficult to appropriately hold the LD56 for BD by holding units 66A, 66B.

In order to prevent this, in the present embodiment, the presser bar 64 is inserted into the hole 15 of the cover so as to support the LD56 for BD at the distal end of the presser bar 64 as illustrated in FIG. 6B. In this manner, when the LD56 for BD is held by the holding units 66A, 66B, the LD56 for BD is prevented from being moved downward, and thus the LD56 for BD can be appropriately held by the holding units 66A, 66B.

After the holding of the LD56 for BD is completed, the pressure of the LD56 for BD applied by the presser bar 64 is released, and the presser bar 64 is drawn out from the inside of the housing 28. Subsequently, a laser beam is emitted from the LD56 for BD, and is received by the PDIC. The positioning of the LD56 for BD is then performed so that a predetermined portion of the PDIC is irradiated with the laser beam. The positioning includes positioning in the X direction, in the Y direction, and in the Z direction, and angle adjustment about each of the axis directions. After the predetermined position of the PDIC is irradiated with the laser beam, an insulating bonding material is coated on the recessed region 58 so as to fix the LD56 for BD to the housing 28. Subsequently, holding by the holding units 66A, 66B is released.

After the above-described steps are completed, various testing processes are performed, and the optical pickup device having the configuration illustrated in FIG. 1 is manufactured.

1-14. (canceled)

15. An optical disc device comprising:
a turntable on which a disk is fixed;
a disk area in which the disk is disposed;
an optical pickup device configured to irradiate the disk with a laser beam; and
a first cover covering the disk area and having an opening through which an objective lens included in the optical pickup device is exposed, wherein
the pickup device includes:
a housing including a plurality of storage spaces formed by a bottom plate, a side wall extending from a periphery of the bottom plate in a direction perpendicular to the bottom plate, and a partition wall contiguous to the bottom plate or the side wall, and a guide projecting from the side wall and configured to movably hold a supporting shaft,
an optical device fixed to the storage spaces,
an actuator which is stored in the storage space, and has a holder holding the objective lens,
a board covering surroundings of the actuator,
a circuit component provided at a position opposite to the turntable across the actuator, and
a second cover coverings the board and the circuit component, wherein
an area of the second cover covers the circuit component is lifted up from the other area.

16. The optical disc device according to claim 15, wherein
one side wall of the housing is curved inward,
the actuator is provided in a vicinity of the curved portion, and
the lifted-up area is provided between the actuator and another side wall at an opposite location to the one side wall.

17. The optical disc device according to claim 16, wherein
the housing has a rectangular shape as a base shape, and forms a planar shape with two covers integral with the other side wall removed, and
the second cover is disposed substantially close to the upper surface of the housing and extends to the lifted-up area via an inclined surface located near the lifted-up area.

18. The optical disc device according to claim 17, wherein
a packaged laser device is stored in a storage portion in the housing, and the second cover is provided with a hole corresponding to the laser device.

19. An optical pickup device comprising:
a housing including a bottom plate, a side wall surrounding a periphery of the bottom plate and extending perpendicularly from the bottom plate, a partition wall extending from an inner side of the bottom plate or the side wall, a storage space having at least the partition wall, an opening of the storage space disposed on an upper side that is opposite to the bottom plate;
a recessed region penetrating a portion of a rear surface of the housing and forming a storage space with the partition wall surrounding the penetrated portion;
an optical device stored in the recessed region;
a plate-shaped cover covering the upper side of the housing;
a hole provided by removing the cover at a portion covering the recessed region; and
a flexible wiring board disposed on the upper side of the housing and configured to be electrically connected to the optical device, wherein
the optical device is connected inside the recessed region via a bending portion of the flexible wiring board.

20. The optical pickup device according to claim 19, wherein
opposite side surfaces of the optical device are each provided with a recessed portion.

21. The optical pickup device according to claim 20, wherein
an inner wall of the recessed region of the housing, which faces one of the recessed portions of the optical device, is partially dented inwardly and thereby provided with a dented region.

22. The optical pickup device according to claim 19, wherein
the optical device is a laser device.

23. A method of manufacturing an optical pickup device configured to emit a laser beam to an information recording medium, and detect the laser beam reflected by the information recording medium, the method comprising the steps of:
preparing a housing having a first principal surface and a second principal surface, the housing being provided with a recessed region, and storing an optical device connected to a flexible wiring board from the first principal surface side to the recessed region;
covering the flexible wiring board disposed on the first principal surface of the housing, with a cover provided with a hole at a position where the optical device is to be disposed; and
positioning the optical device by pressing the optical device using a pressing unit inserted into the housing through the hole of the cover from the first principal surface side, wherein
in the step of positioning, the optical device is temporarily attached inside the recessed region of the housing by a bending portion of the flexible wiring board.

24. The method of manufacturing an optical pickup device according to claim 23, wherein
opposite side surfaces of the optical device are each provided with a recessed portion, and
in the step of positioning, the optical device is positioned by a holding unit holding the recessed portions from the second principal surface side.

25. The method of manufacturing an optical pickup device according to claim 24, wherein
an inner wall of the recessed region of the housing, which faces one of the recessed portions of the optical device, is partially dented inwardly and thereby provided with a dented region, and
the holding unit is inserted between the recessed portions of the optical device, and the dented regions of the housing.

26. The method of manufacturing an optical pickup device according to any one of claim 23, wherein
the optical device is a laser device, and
in the step of positioning, the optical device is positioned so that a predetermined position of a light-receiving device is irradiated with a laser beam emitted from the laser device.
